(19) United States
(12) Patent Application Publication
(10) Pub. No.: US 2013/0024396 A1
(43) Pub. Date: Jan. 24, 2013

(54) Systems and Methods for Determining Cost of Capital for an Entity in a Bottom-Up, Fully Risk-Based Manner

(71) Applicants: Martin C. Wilhelm, Cologne (DE); Michael E. Pati, Chicago, IL (US); Felicisimo Galicia, Bothell, WA (US); Keyur K. Patel, Fairfield, CT (US)

(72) Inventors: Martin C. Wilhelm, Cologne (DE); Michael E. Pati, Chicago, IL (US); Felicisimo Galicia, Bothell, WA (US); Keyur K. Patel, Fairfield, CT (US); Ozsgur Sozen, Chicago, IL (US)

(21) Appl. No.: 13/301,033

(22) Filed: Nov. 21, 2011

Related U.S. Application Data
(63) Continuation of application No. 13/079,433, filed on Apr. 4, 2011, now abandoned.
Application No. 13/079,433 is a continuation of application No. 12/860,463, filed on Aug. 20, 2010, now abandoned.
Application No. 12/860,463 is a continuation of application No. 12/683,563, filed on Jan. 7, 2010, now abandoned.
Application No. 12/683,563 is a continuation of application No. 12/471,933, filed on May 26, 2009, now abandoned.
Application No. 12/471,933 is a continuation of application No. 12/247,041, filed on Oct. 7, 2008, now abandoned.
Application No. 12/247,041 is a continuation of application No. 11/910,176, now abandoned.
(60) Provisional application No. 60/665,656, filed on Mar. 28, 2005.

(51) Int. Cl. G06Q 40/06

(52) U.S. Cl. 705/36 R

(57) ABSTRACT

The present invention relates generally to determining cost-of-capital in a bottom-up, fully risk based manner. In particular, the present invention relates to methods, systems, and software tools for calculating the cost-of-capital for a business entity. One or more risk drivers are provided by identifying one or more scenarios and quantifying the drivers for each scenario. Based on the risk drivers, one or more entity returns, and optionally one or more market returns, are determined, and based on the entity returns and optionally the market returns, one or more entity risk measures are determined. A cost-of-capital for the entity may be determined based on one or more of the entity risk measures.

### CROSS-REFERENCE TO RELATED APPLICATION

This application claims the priority of U.S. Application No. 60/665,656, filed Mar. 28, 2005, which is incorporated by reference herein.

### FIELD OF THE INVENTION

The present invention relates generally to determining cost-of-capital in a bottom-up, fully risk based manner. In particular, the present invention relates to methods, systems, and software tools for calculating the cost-of-capital for a business entity. One or more risk drivers are provided by identifying one or more scenarios and quantifying the risk drivers for each scenario. Based on the risk drivers, one or more entity returns, and optionally one or more market returns, are determined, and based on the entity returns and optionally the market returns, one or more entity risk measures are determined. A cost-of-capital for the entity may be determined based on one or more of the entity risk measures.

### BACKGROUND OF THE INVENTION

Cost-of-capital is an expected rate of return for investors on an investment alternative. Put differently, the cost-of-capital is an opportunity cost, in percentage terms, an investor faces on employed capital. When an accurate method of determining cost-of-capital is used, investment alternatives with similar risk profiles should have nearly the same cost-of-capital, and a risky investment alternative should yield a higher cost-of-capital relative to a less risky investment alternative.

Industry restructuring has exposed electric utilities and their investors to a multitude of new risks for which they should be appropriately compensated. Standard methods for cost-of-capital estimation fail to incorporate these risks in an adequate manner. This situation directly threatens not only individual companies, but also the reliability and security of the overall system infrastructure.

Although separating the generation and wires (transmission and distribution) parts of the business could be viewed as shielding a regulated utility from major sources of risk (since they are not directly exposed to volatile wholesale markets) another look at the situation reveals a variety of new risks. Since the wires segment of the business is, or will, no longer be tightly integrated with the rest of the industry, the industry cannot take full advantage of internal hedges it once enjoyed, such as the coordination of planning from generation through eventual delivery. In particular, although power purchase agreements (PPA's) have been negotiated historically with affiliates, the regulated utility might be in a better situation to manage its portfolio through a variety of suppliers in the open market. Even in situations where PPA's are signed, there is no guarantee that an appropriate regulated rate will be granted to serve as a “pass-through.” Furthermore, there is substantial risk that the time structure of the PPA's and the rates determined by a regulator will not perfectly coincide. In other cases, the PPA's may specify bounds on how much delivered load can differ from a pre-specified schedule, exposing the utility to significant volumetric risk.

The transmission business is also exposed to risks due to the changing way in which the transmission system is accessed. Furthermore, in a competitive retail environment, a utility distribution company (UDC) may have a regulatory obligation to serve as a provider-of-last-resort (POLR). Providing POLR services requires that the UDC stand ready to serve the customer. The frequency with which POLR services are required is subject to uncertainty and translates into additional risks for the UDC.

These factors and others will prompt investors to require a rate-of-return that compensates them for the risks borne by holding regulated utilities, directly or via holding companies, in their portfolio. Proper incentives must be given to investors in order raise the capital necessary to finance transmission and distribution infrastructure extensions and improvements. To prevent erosion of reliability and security of the grid, it is imperative that regulators and public policy makers, utility senior management, and shareholders communicate the proper signals to investors, analysts, and others.

Existing techniques for determining cost of capital do not fully incorporate the risks borne by utilities in a restructured environment. Standard methods tend to be based on historical observations and are intrinsically backward looking. In addition, they utilize oversimplified measures of risk exposure. Furthermore, the usual approaches have difficulty separating the risks of a publicly traded holding company into those of its operational subsidiaries. Finally, existing techniques do not enable cost-of-capital to be broken down into components, making the relative importance of risk drivers less than transparent.

Thus, there is a need for a methodology and supporting systems and software designed to calculate cost-of-capital in a bottom-up, fully risk based manner. There is also a need for the use of such embodiments for ratemaking, regulatory negotiation, asset valuation, investment valuation, planning, decision-making, budgeting, risk management and other uses.

### BRIEF SUMMARY OF THE INVENTION

In one aspect, the present invention provides methods for determining a cost-of-capital for a business entity. One or more risk drivers are provided by identifying one or more scenarios and quantifying the risk drivers for each scenario. Based on the risk drivers, one or more entity returns, and optionally one or more market returns, are determined, and based on the entity returns and optionally the market returns, one or more entity risk measures are determined. A cost-of-capital for the entity may be determined based on one or more of the entity risk measures. The cost-of-capital may be used in numerous ways, such as for determining a price or rate for goods or services based on the cost-of-capital for the entity, or determining a capital charge based on the cost-of-capital for the entity, or determining a tax liability of the entity based on the cost-of-capital for the entity, or determining a budget for the entity based on the cost-of-capital for the entity, or acquiring or selling an entity based on the cost-of-capital for the entity, or offering to acquire or sell an entity based on the cost-of-capital for the entity.

In another aspect, the present invention provides systems for calculating a cost-of-capital for a business entity. The systems comprise a module for quantifying one or more risk drivers for one or more scenarios, and a module for determining entity returns and optionally market returns based on the risk drivers. The systems can also comprise a module for determining one or more entity risk measures based on the entity returns and optionally the market returns. The systems can also comprise a module for determining a cost-of-capital based on the entity risk measure(s). The systems can also comprise a module for displaying the cost-of-capital, the entity risk measures, the returns, the risk drivers, and/or other values. The systems can also comprise a computer hardware architecture having one or more computer processors.

In yet another aspect, the present invention provides computer-readable storage media which include instructions for a computer. The instructions comprise a scenario specification routine for identifying one or more scenarios and providing one or more risk drivers based on at least one identified scenario. The instructions also comprise a return series determination routine for using the one or more risk drivers to determine one or more entity returns, and optionally one or more market returns. The instructions also comprise a risk measure determination routine for using the entity returns and optionally the market returns to determine one or more entity risk measures. The instructions also comprise a cost-of-capital determination routine for using the one or more entity risk measures to determine a cost-of-capital for the entity. The instructions can also comprise a display routine for displaying the cost-of-capital or other determined values (entity risk measures, returns, or risk drivers). The instructions can also comprise a computer software architecture utilizing single or multiple computer processors.

In the foregoing methods, systems and computer readable media, entity returns and/or market returns may be determined using price-proxies. Price-proxies may be determined based on the risk drivers. Additionally, entity returns and/or market returns may be determined by mapping the risk drivers to the entity returns.

The scenarios may be industry risk scenarios, market risk scenarios, regulatory risk scenarios, investment risk scenarios, or macroeconomic risk scenario, as well as any other scenario(s) having a potential impact on one or more risk drivers. Examples of industry risk scenarios include utility restructuring/unbundling, changes in the competitive landscape, changes in a utility's service obligations, changes in the energy needs of end-users (amounts, flexibility), or unexpected load growth. Examples of market scenarios include changing volatilities and mean prices in wholesale energy markets, or increased sophistication and product development requirements in competitive retail markets. Examples of regulatory scenarios include performance based ratemaking, adoption of demand response mechanisms, or evolving environmental constraints on the utility. Examples of investment scenarios include build or buy decisions, variations in maintenance costs, system infrastructure extension decisions, asset mix reassessments, or M&A activities. Examples of macroeconomic scenarios include changes in interest rates, gross domestic product (GDP), or technological advancement.

In the present methods, systems and computer readable media, the risk drivers may be one or more of a cash flow component and a fundamental factor. The cash flow components may be one or more of an earnings component or a free cash flow. The earnings components and the free cash flows may be one or more of a revenue and a cost. The revenues may be one or more of retail revenues and wholesale revenues, and the costs may be one or more of procurement costs, retail revenues, transmission costs, generation costs, operation costs, and maintenance casts. Fundamental factors include one or more of industry, macroeconomic, and entity-specific variables. Examples of industry variables include industry market prices and substitute product prices. Examples of macroeconomic variables include gross domestic product, interest rates, and oil prices. Examples of entity-specific variables comprise one or more of temperature and load growth.

In the present methods, systems and computer readable media, the entity risk measure may be a measure of non-diversifiable risk or total risk.

The present methods, systems and media can be used for a wide variety of entities, including an electric utility, a gas company, an oil company, a company whose cash flow is subject to regulatory determination, a company or subsidiary that does not have publicly traded stock shares, a company whose industry is undergoing deregulation, a generation asset, a transmission asset, a distribution asset, an information technology asset, an energy management system (EMS) asset, an automated metering system (AMS) asset, a pipeline asset, a refinery asset, an exploration asset, or a project based upon said assets.

The scenarios may be identified using any suitable technique, including but not limited to using historical simulation, Monte Carlo simulation, correlation structure analysis, and intuitive specification through sensitivity analysis.

The price-proxies can be determined using any suitable technique, including but not limited to a discounted cash flow (DCF) method, a price-to-earnings (P/E) ratio method, a stochastic price model, a stock price of a comparable company, a stock price of the holding company of the entity, and a stock price of the entity.

The entity risk measure can be determined using any suitable technique, including but not limited to the following methods: variances and covariances, Value-at-Risk (VaR), and Expected Tail Loss (ETL).

The present methods, systems and computer readable media may also include some or all of the following: decomposing, or means for decomposing, at least one of the entity cost-of-capital, the entity risk measure, and the entity returns into cash flow components; renormalizing, or means for renormalizing, the cash flow decomposition of the entity cost-of-capital so that a sum of elements of the renormalized cash flow decomposition of the entity cost-of-capital is equal to the total entity cost-of-capital; displaying, or means for displaying, the said sum of the renormalized cash flow decomposition of the entity cost-of-capital; renormalizing, or means for renormalizing, the cash flow decomposition of the entity risk measure so that a sum of elements of the renormalized cash flow decomposition of the entity risk measure is equal to the total entity risk measure; displaying, or means for displaying, the sum of the renormalized cash flow decomposition of the entity risk measure; renormalizing the cash flow decomposition of the entity returns so that a sum of elements of the renormalized cash flow decomposition of the entity returns is equal to the total entity returns; displaying the said sum of the renormalized cash flow decomposition of the entity returns; and/or decomposing at least one of the entity cost-of-capital, the entity risk measure, and the entity returns into a plurality of fundamental factors; displaying, or means for displaying, at least one of the entity cost-of-capital, the entity risk measure, and the entity returns in a waterfall plot using a sum of sample moments of the quantified fundamental factors and sensitivities of the quantified fundamental factors.

In the present methods, systems and computer readable media, the decomposition may be achieved through time-series analysis and economic-reasoning analysis. The time-series analysis may be carried out by one or more of ordinary least squares (OLS) methods, generalized least squares methods, maximum likelihood estimation (MLE), and generalized method of moments (GMM) techniques.

In the present methods, systems and computer readable media, the risk measure can be related to the cost-of-capital in at least one of linear, multi-linear, and non-linear fashion.

The foregoing summary, as well as the following detailed description of certain embodiments of the present invention, will be better understood when read in conjunction with the drawings. For the purpose of illustrating the invention, certain embodiments are shown in the drawings. It should be understood, however, that the present invention is not limited to the arrangements and instrumentality shown in the drawings.

### BRIEF DESCRIPTION OF THE DRAWINGS

FIG. 1 illustrates a breakdown of risk drivers into subcategories.

FIG. 2 illustrates a flowchart for price-proxy return series determination.

FIG. 3 illustrates a flowchart diagram of a recursive Batch Regression process. The process loops until conditions that finalize the process have been met. The five different key points represent the points where decisions have to be made.

FIG. 4 illustrates an example of a decomposition of company earnings for a regulated utility and how they are simulated under changing conditions. Earnings are calculated by putting together individual revenue and cost items.

FIG. 5 illustrates the break down of 12 months of earnings into cost and revenue components.

FIG. 6 illustrates two graphs, the top one displays the DCF projection process and the bottom one displays returns of the DCF-generated price-proxy. The two red lines in the graph are the DCF projections of free-cash-flows at two separate points. They incorporate the same historical seasonality but forecast different levels due to the differences in the data window used for forecasts at the two different points in time.

FIG. 7 illustrates how components of earnings contribute to the overall risk measure (Beta). As opposed to the risk factors, these are components that are used to simulate earnings under different scenarios.

FIG. 8 illustrates a waterfall graph that provides an example of how the total risk measure (Beta) is expressed in terms of pairs of individual underlying risk factors. Each pair of risk factors contributes to the overall relative risk measure.

FIG. 9 illustrates a bar plot of the risk measure (e.g., Beta) increasing under three increasingly riskier scenarios. PPA (Power Purchase Agreement) scenario refers to a situation where power is purchased at a fixed cost throughout the period. Forward and Spot scenario is a mixture of forward contract purchases and spot market purchases. In the Spot scenario, all power is purchased in a day-ahead spot market.

FIG. 10 is an overall flowchart of an illustrative computer system implementation of the invention for the case where a non-diversifiable risk measure is chosen to calculate a forward looking cost-of-capital.

FIG. 11 is a flowchart describing an illustrative computer system implementation of Module 1002, Scenario Specification, in further detail.

FIG. 12 is a flowchart describing an illustrative computer system implementation of Module 1004, Price-Proxy Return Series Determination, in further detail.

FIG. 13 is a flowchart describing an illustrative computer system implementation of Module 1006, Non-Diversifiable Risk Measure Determination, in further detail.

FIG. 14 is a flowchart describing an illustrative computer system implementation of Module 1010, Cost of Capital Determination, in further detail.

### DETAILED DESCRIPTION OF THE INVENTION

The present disclosure provides novel methods, systems and media for determining cost-of-capital, as well as novel substeps and modules. For example, the present disclosure provides novel methods, systems and media for determining risk factors, returns, and or risk measures, as described in more detail herein.

In the present methods and systems, determining can include estimating, calculating, specifying, computing, or any other action that uses company input data with the intention of arriving at quantitative results for cost-of-capital, independent of the intended use. In the present methods and systems, when an output is determined based on an input, it can be determined based entirely on that input or based in part on that input (and one or more other inputs or factors). In the present methods and systems, entity includes corporation, holding company, subsidiary, division, partnership, asset, and project. In the present methods and systems, returns can be in the form of a time series of values. In the present methods and systems, price proxies can be in the form of a time series of values.

Although many of the examples cited in the description are drawn from the electric power industry, the present methods and systems are sufficiently general as to be well suited for many other industries and business sectors. Other relevant industries and business sectors include but are not limited to gas, oil, companies whose cash flow is subject to regulatory determination, an entity that does not have publicly traded stock shares, or a company whose industry is undergoing deregulation.

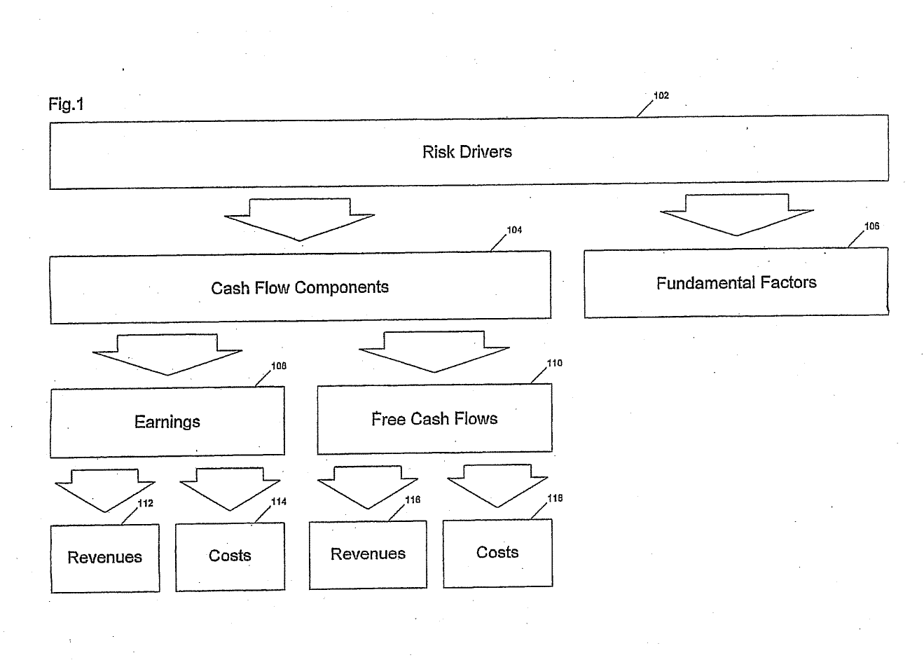

FIG. 1 shows a breakdown of the subcategories for the risk drivers in a preferred embodiment. Risk drivers comprise cash flow components and fundamental factors as indicated in steps 102, 104, 106. Cash flow components comprise earnings and free cash flows as indicated in steps 104, 108, 110. Earnings and free cash flow both comprise revenues and costs as indicated in steps 108, 112, 114 and steps 110, 116, 118 respectively. Example fundamental factors include temperature, gross domestic product, load growth, interest rates, oil prices, and many others. Example revenues include retail revenues, wholesale revenues, as well as others. Example costs include procurement costs, retail revenues, transmission costs, generation costs, operation costs, and maintenance costs, as well as others.

### Scenario Specification

The present methods and systems generally include the identification (specification) and use of one or more scenarios. Each scenario comprises one or more future events having a potential impact on one or more risk drivers. In identifying the scenarios, the events and outcomes that could affect the utility's cash flows are identified and analyzed. A scenario either can be based upon choices among relevant participants or possible outcomes under various operating constraints. For example, in an open wholesale market, a utility may have many possible procurement alternatives. For example, the utility could procure power via power purchase agreements, forward contracts, spot market purchases, or a combination thereof. Similarly, a regulator has control over the market and industry rules to which utilities are subjected. At the same time, many underlying variables are not under any participant's direct control, such as temperature, market prices, and load fluctuations.

After one or more potential industry, regulatory, and market scenarios are identified qualitatively, they are linked quantitatively to risk drivers. The risk drivers can be modeled directly. This could involve modeling explicit components of a company's cash flows or a more fundamental set of macroeconomic or industry factors. For example, a cash flow component could be the utility's procurement cost, or a fundamental factor could be temperature. The market portfolio, usually represented by a stock index, can be used to project the risk that is non-diversifiable, and can be analyzed via forward looking scenarios. Scenarios can be incorporated via historical simulation, Monte Carlo simulation, analysis of correlation (or higher moment) structures, or intuitive changes in input parameters.

The first step of some embodiments of the present methodology is to determine the scenarios that impact the company's cost-of-capital and to link them to the risk drivers that are used to model uncertainty.

In the present methods and systems, a scenario is a qualitative description of events that occur in the regulatory, industry, market, investment, or macroeconomic environment and the ensuing quantitative response in the underlying risk factors. In the present methods and systems, the risk drivers include fundamental risk factors or cash flow components. Examples of fundamental risk factors are interest rates, gross domestic product (GDP), and temperature. The fundamental risk factors are selected from a large pool of macroeconomic, industry, and regional data as described further below. In the present methods and systems, the cash flow components include earnings or free cash flow items specific to the company. Examples of cash flow components are procurement costs, maintenance costs, and retail revenues.

In the present methods and systems, scenarios are based on choices particular industry participants make. An example of this is given by a particular choice of procurement. A utility can procure electricity to cover its retail load in a number of different ways. For instance, the utility could enter into a full requirements contract which gives the right to buy whatever electricity is required, independent of realized load shape, at a fixed $/MWh price. Alternatively, in an open market the utility could manage its own portfolio by purchasing a mixture of liquid forward contracts and buying the residual required amounts in the spot market. These two situations have very different risk profiles and in general lead to different cost-of-capital estimates. Another example of a participant influenced scenario would be the situation where specific choices of regulatory mechanisms are introduced, since the regulator has direct control over these variables. For instance, the regulator can impose different environmental or market rules that affect a utilities risk exposure.

In the present methods and systems, scenarios are based on variables that are not under the direct control of participants. For instance, in the procurement example, although the choice of procurement is under a participant's control, the market prices are not. Therefore, price scenarios can be considered when calculating cost-of-capital estimates. Similarly, although the regulator can choose which regulatory mechanisms to put in place, the impact of these mechanisms on the utility is uncertain and depends on the details of a host of other variables. For example, if new environmental rules are put in place, the specific characteristics of a utility's asset base must be modeled in the presence of these rules.

In the present methods and systems, scenarios fall under the categories of industry, market, regulatory, investment, macroeconomic, and other. Examples of industry scenarios include utility restructuring/unbundling, changes in the competitive landscape, changes in a utility's service obligations, changes in the energy needs of end-users (amounts, flexibility), and unexpected load growth. Market scenarios include changing volatilities and mean energy prices in wholesale power and fuel markets, as well as increased sophistication and product development requirements in competitive retail markets. Regulatory scenarios include performance based ratemaking, adoption of demand response mechanisms, and evolving environmental constraints on the utility. Investment scenarios include build or buy decisions, variations in maintenance costs, system infrastructure extension decisions, asset mix reassessment, and M&A activities. Macroeconomic scenarios include uncertain changes in interest rates, GDP, and technological advancement. Other scenarios include, but are not limited to, temperature anomalies, conservation efforts, and energy substitution.

The occurrence of events within these scenario categories induces cash flow or fundamental factor scenarios. In the present methods and systems, cash flow scenarios are a series of events that affect earnings or free cash flow realizations. For example, different procurement strategies lead to different electricity costs. Therefore, under different scenarios it is possible to find the resulting change in particular cash flow line items. In another embodiment, fundamental factor scenarios take the scenario types and map them to possible changes in the underlying fundamental factors. Either, or both, the cash flow or factor scenario approach can be implemented as embodiments of the present invention.

The present methods and systems analyze cost-of-capital in a forward looking manner. Therefore, the present methods and systems can incorporate randomness or uncertainty in a number of ways. Each of the alternatives described here is considered as an embodiment of the invention. In addition, these alternatives can be hybridized and the resulting hybridization and the associated results are considered further embodiments of the present invention.

The idea behind historical simulation is to utilize observable time series of the underlying factors or cash flow components. This could be done by incorporating past time series for core variables explicitly into the analysis and treating them as if they are forward looking realizations in a manner similar to Monte Carlo simulation. Instead of drawing a random sequence from a distribution, the utilized sequence is given by that which actually occurred for a given variable of interest. Alternatively, this technique could be restricted to a subset of variables that are difficult to model using other, more forward looking, methods.

Historical simulation can be used in conjunction with some of the other techniques below to obtain improved estimates. It is also useful for looking at what a company's cost-of-capital should have been in the past and how it has evolved dynamically over time.

Monte Carlo simulation uses a numerical algorithm for generating random numbers. The random numbers are used in conjunction with an economic model for the underlying variables of interest to create random time series realizations. Each realization, which is a sequence of random numbers, is considered a single simulation for a modeled variable. A particular estimate of cost-of-capital is formed for each simulation of the complete set of modeled variables. Many simulations of the complete set of variables are performed and the cost-of-capital estimate can be formed from particular estimates.

A key advantage of Monte Carlo simulation is that it is very flexible. In particular, it can incorporate any desired probability distribution. Furthermore, since it is not directly using historical realizations, there is no restriction on the length of the time series used. Monte Carlo simulation can be used in conjunction with historical simulation to provide greater flexibility.

The analytic correlation structure approach is an add-on to historical simulation, whereby a more forward looking approach is achieved. A chosen risk measure will depend on correlations and higher order, cross moments (moments of products of variables). The idea of this technique is to map forward looking scenarios to an estimate for how these moments are perturbed from their previous historical values to their new forward looking values. Under Monte Carlo simulation this process is handled behind the scenes. An approach based upon analysis of the moment structure enables more direct control over the process.

Intuitive specification is really just informal sensitivity, analysis and can be used in conjunction with any of the previously mentioned techniques. An example in the historical simulation approach is to modify one component of the cash flows in a way that leaves its time series “shape” unchanged. This could be done by ensuring that the same relative changes take place at each time step, which can be achieved by scaling the time series by an overall factor. This may lead to significant insight regarding the sensitivity of the overall cost-of-capital estimate on this variable. An example in the Monte Carlo approach is to choose values for input parameters that are different from those implied by historical data, based upon intuition or recent information. A spectrum of new values may be chosen to analyze the sensitivity of results on the particular choices. An example in the correlation structure approach is to choose a wide variety of moment perturbations, including those that are outside of the original model that specified the magnitude of these perturbations. By analyzing the impact on cost-of-capital estimates and determining implicitly what scenarios the chosen moment structure imply, it may be possible to better assess the validity of the moment perturbation models.

### Price-Proxy Return Series Determination

The present methods and systems can be used for determining one or more entity returns, and optionally one or more market returns. In order to link risk drivers to entity and market returns, a price-proxy model is determined. This facilitates the use of the present methods and systems with unlisted companies, subsidiaries of holding companies, specific company assets, specific company projects, M&A targets, holding companies and other entities. The price-proxy provides a model that induces appropriate statistical properties in the generated return time series. In the present methods and systems, price proxies are based upon price-earnings (P/E) ratios, discounted cash flow (DCF) valuation methods, and/or any technique that maps company cash flows to price returns. Additionally, price returns can be decomposed according to the risk drivers and analyzed across scenarios, giving greater intuition regarding the sources of risk exposure and their forward evolution, as well as a solidified basis for decision making. This is done by assuming some functional relationship between the returns and the factors and determining free parameters by statistical estimation.

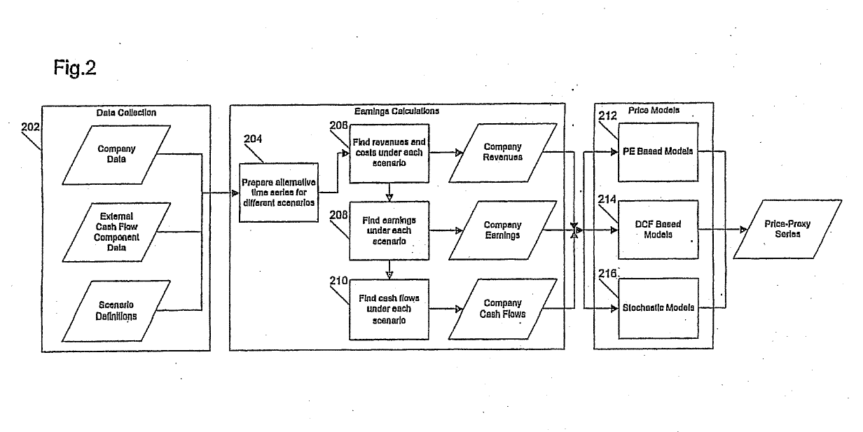

FIG. 2 illustrates a flow diagram for determining a price-proxy series in accordance with the present methods and systems in the special case where the entity is a company (as opposed to an asset or project). The present methodology uses defined scenarios and/or related data to calculate cash flow components, summing up to earnings and free-cash-flow amounts for a company, asset, or project throughout a historical or forward-looking time interval. The earnings and free-cash-flow amounts are used to calculate a price-proxy. A price-proxy, in the present methods and systems, is a simulated theoretical stock price for the company, which may be privately owned with no real stock price information available. It can also be viewed as the value of a particular asset or project that may not have a transparent market for comparables. In the present methods and systems, price-proxy determination focuses on determining stock price proxies for companies. Similar considerations would apply for calculating a value for assets or projects.

First, at step 202, data is collected about the company in question. This data can be actual historical data or can be generated. For forward-looking time intervals, the data can consist of company or industry forecasts. In the present methods and systems, the data includes a detailed breakdown of company earnings into individual cost and revenue items. Time series with highest available frequency for all of these individual items are collected. For example, individual items include, but are not limited to: retail revenue (from different customer segments), wholesale revenue, other operating revenue, generation costs, power procurement costs, wheeling costs, fixed plant costs, power operations costs, transmission and distribution costs, customer service costs, other operations and maintenance related costs, depreciation, amortization, taxes and other deductions.

In the present methods and systems, the items that relate directly to the exchange of a certain type of commodity significant to the business of the company (such as power, gas, oil, coal, biomass and other fuel types) are further broken down into the quantities purchased or sold and the prices paid or charged. Such items include but are not limited to: retail revenue, generation costs for each individual generation asset (plant), costs relating to power procurement and revenues from power sales outside of retail markets.

The data is then modified to be of common frequency (annual, quarterly, monthly or daily). Items that will be included in earnings but not under free cash flows are marked. Among those items whose tax benefit will be included in the free cash flows (such as depreciation) are marked as well.

Next, at step 204, several alternative time series for each item and sub-item (such as prices and amounts) are generated using scenario definitions. Any item can have as many alternative time series as the number of scenarios that require that particular item to have different values. For example, besides the actual power prices paid, the purchased power price item can have several alternative time series of power prices from different markets. This allows earnings to be simulated under different market scenarios.

These items and sub-items are then put back together for each scenario to recreate utility earnings under different scenarios. At step 206, sub-items (divided into price and quantities) are put back together to get total cost and revenue series. Then, at step 208, cost items are subtracted from revenue items to find the total profits (earnings) series.

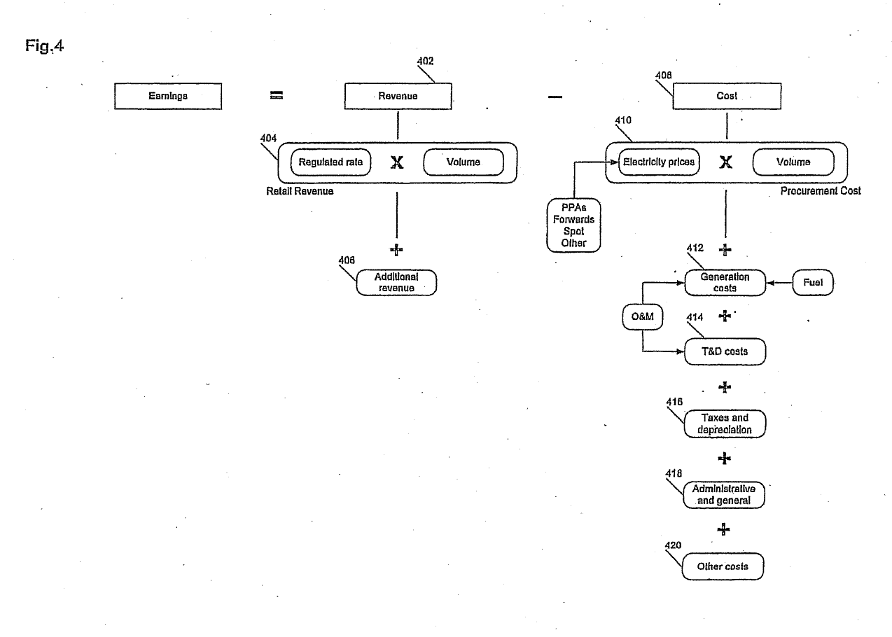

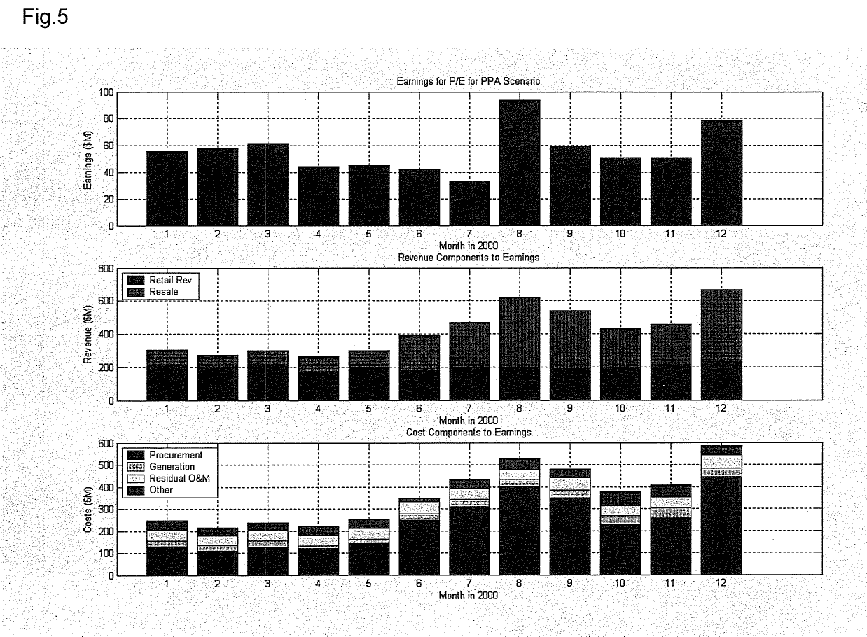

A schematic breakdown of earnings components is given in FIG. 4. This diagram splits earnings into revenues 402 and costs 408. Revenues are further broken down into retail revenues 404 and additional revenues 406. Costs are broken down into procurement costs 410, generation costs 412, transmission and distribution costs 414, taxes and depreciation 416, administrative and general costs 418, and other costs 420. This diagram is merely an example and suitable generalizations would be implied if an embodiment was applied to a company in a different business area (or a different entity such as an asset or a project). A visual representation of the earnings, revenue, and cost time series is given in FIG. 5.

Regarding FIG. 2, at step 210 the earnings are reduced by a tax rate and form free cash flows so that accounting biases are removed. The outputs significant for the remainder of the methodology are the earnings series, free-cash-flow series and the total revenue series. All other components of earnings and cash-flows are also outputs, including time series of individual items, or sums of groups of items (such as total procurement costs, total generation costs etc.) can also be retrieved from this process as outputs.

In the present methods and systems, if the company is public, one time series that can be used for the price proxy is the company's actual stock price. Otherwise, when the company is not public or when it is desired that the scenarios in the previous step be reflected in various risk calculations, a proxy is needed for the company's would-be stock price. At steps 212, 214, and 216 in FIG. 2, the outputs of the previous process (i.e. earnings, free-cash-flows and revenues) are used with price models 212, 214, and 216 to calculate that price-proxy.

P/E based models use the earnings time series and assumptions on the Price-to-Earnings (P/E) ratio to get a price-proxy. The P/E ratio at any given point in time is defined as the ratio of the stock price at that time to the sum of the earnings-per-share of the company in the past 12 months. This is the standard convention. P/E ratios can be formed under different time horizons and can be formed from weighted averages as well to give greater (or lesser) emphasis to more recent values.

An example of a P/E based price model is assuming a constant P/E ratio. Another example of a P/E based price model uses P/E time series from a variety of sources. The following are examples of feasible P/E time series: P/E ratio of a market index (such as the S&P 500) or the P/E ratio of an index relevant to the company (such as Dow Jones Utilities Index) or the collective P/E ratio of a group of comparable companies (such as the ratio of the total price of a group of similar utilities to their total earnings-per-share for the last 12 months). One could also use the P/E ratio of the parent company itself, if it exists.

DCF based models provide an alternative method for determining a price proxy. This approach takes place in two phases. First, cash flow projections must be made. One way this can be done is by estimating the seasonal nature of free cash flows on a monthly basis (either using a least squares fit to a sine curve or taking the historical average directly) and running a linear regression to determine growth on free cash flows after seasonality is removed. This growth and seasonality can then be used to project free cash flows moving forward. Projected free cash flows are then discounted to determine the value of the firm (or asset).

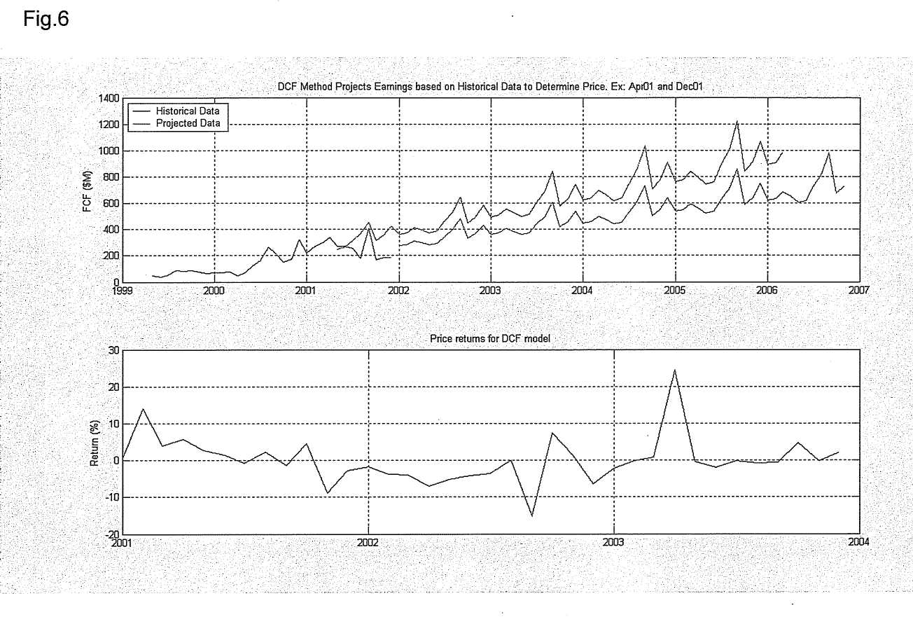

The DCF approach has a number of input parameters including the discount rate, the terminal value growth rate, the year in which to compute the terminal value, the number of historical months to estimate the short-term growth rate, and the method for including seasonality (sine wave fit or historical). To be fully consistent, the discount rate should match the eventual cost-of-capital. However, since this step is used only to generate a return time series and since the final results are more sensitive to the time structure and relative values of this time series, specifying a discount rate that is of the correct order of magnitude is likely to be sufficient. Alternatively, the analysis can be handled iteratively in an embodiment by enforcing this matching constraint and repeating until the two quantities are in fact equal. An example of the output for the cash flow projection and for the ensuing return series is given in FIG. 6.

Stochastic approaches use a statistical model of price dynamics by specifying a stochastic difference equation and using this to generate return time series via Monte Carlo simulation. This involves determining the free parameters in the stochastic difference equation through some form of estimation based upon historical data or by specifying their values based upon intuition or other information.

### Risk Measure Determination

The present methods and systems provide improved techniques of risk measure determination. A risk measure is the quantity used to relate entity returns to cost-of-capital. A risk metric is a technique for quantifying risk exposure that is used to compute a risk measure using a portfolio (i.e. risk-return) analysis. Traditional approaches to risk measure determination rely solely on standard deviations and covariances as risk metrics to determine the risk exposure a company faces. These risk metrics are less satisfactory in situations in which low probability events are expected to occur more frequently than specified by a normal distribution. The present systems and methods are generally applicable to any risk metric or associated risk measure. Examples of risk metrics include Value-at-Risk (VaR) and Expected-Tail-Loss (ETL). Both VaR and ETL have the advantage that they do not make assumptions about the distributions of the underlying risk drivers. The risk metric chosen can replace standard deviations and covariances in a portfolio selection problem. This process maps excess company returns to excess market returns via a functional expansion where the individual terms in the expansion are determined by the resulting risk measure.

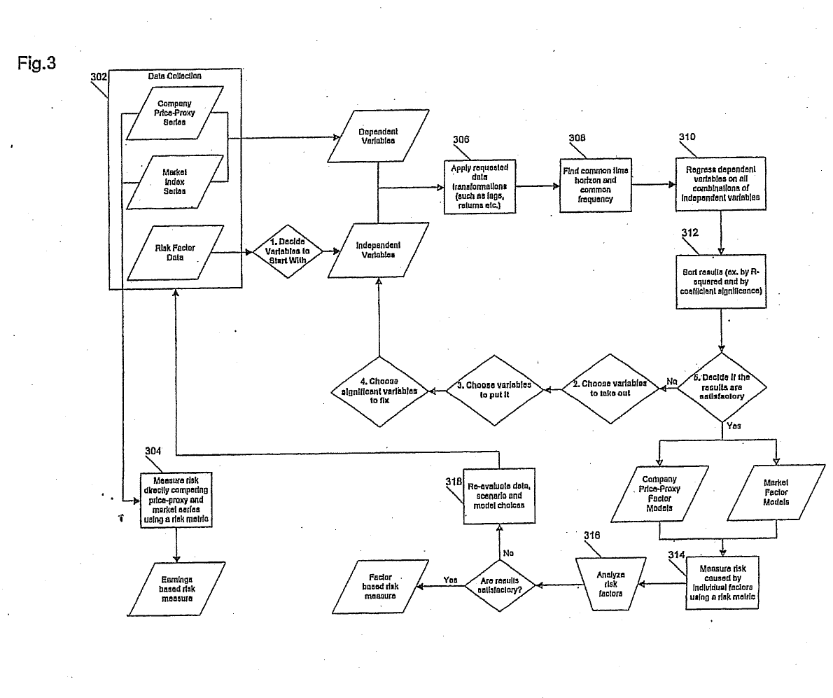

FIG. 3 illustrates a flow diagram for determining a risk measure where only the non-diversifiable risk is analyzed in accordance with an embodiment of the present invention. The present methodology uses risk measures to decompose and analyze the risk in the company's operation. For example, in situations where non-diversifiable risk is the main focus this can be done by comparing returns to those of a portfolio representing the entire spectrum of investment opportunities (usually taken to be a stock index).

It is important to note that the methodology can focus on the non-diversifiable component of a company's risk exposure or the total risk, including the contribution from the “diversifiable” component. Strictly speaking diversifiable risk should not result in risk premia according to financial portfolio theory, however some types of risks that may be classified as “diversifiable” may actually be difficult or involve extra costs to diversify. This could be because of the limited set of alternative investments available for diversification purposes or due to a preferred incentive to hold certain types of assets or companies in an investment portfolio. Furthermore, companies may be interested in the overall risk exposure that they face. Although, in most of the discussion below the non-diversifiable component of risk is the primary focus, it should be stressed that the overall risk and the resulting cost-of-capital can also be analyzed using embodiments of the present invention.

In FIG. 3, at step 304, time series of price (or price-proxy) for the company and time series of a market index (such as the S&P 500) can be used directly, without decomposition, to calculate the risk of a company's operations in relation to the market, using a particular risk measure. An example of a risk measure is the traditional Capital Asset Pricing Model (CAPM) Beta. This and other risk measures unique to the methodology are discussed further, later in this section.

One possible embodiment assumes that the entity price returns and the market index returns are influenced by a number of macroeconomic and local factors. This is not an essential step, however, factor decomposition provides greater intuition since it enables fundamental variables to be modeled explicitly. Alternatively, cash flow components could be modeled directly to form price return time series.

The following steps, therefore, isolate these factors from an initial comprehensive factor pool and decompose the entity price (or price-proxy) returns and the market index returns into these significant factors. This decomposition makes use of a batch regression technique to regress the price and market returns on all combinations of variables in the factor pool to determine which regression model constitutes the best decomposition.

In FIG. 3, at step 302, data is collected for the comprehensive factor pool. Data collected includes as many macroeconomic factors as possible, in the form of time series with the highest length and frequency available. The process to decide which factors are relevant to be included in this comprehensive pool is based upon economic reasoning. Examples of such factors include, but are not limited to, consumer price index, personal consumption, personal income, trade balance, non-farm employment, GDP (Gross Domestic Product), GDP volatility, money supply, total retail sales, oil prices, natural gas prices, coal prices, unemployment rate, labor force, treasury bill returns, energy costs, total consumed power, local temperature, population, population growth, house sales, total consumer credit, corporate bond yields, and/or corporate bond-treasury bill spreads.

In the present methods and systems, most of the same factor pool can be used for both company side and market side regressions. But local time series (such as temperature, system load) are not expected to influence market returns and therefore can be excluded from the market side regressions.

The goal of the batch regression method is to find the best model to describe a dependent variable (the returns on the company stock price-proxy or the market index) as a linear function of a group of independent variables (fundamental factors or just “factors” for short). In the present methods and systems, the batch regression process takes time series for the dependent variable (i.e. returns) and a large number of independent variables (i.e. factors). Some of the factors may have lags and the data points at a certain point in time of these factors may affect the returns at a later point in time.

In FIG. 3, at step 306, the datasets of factors that are marked to have certain amounts of lags are shifted forward in time to incorporate the lag. Several lags of the same variable can be tested all at once by including several copies of the same dataset with different amounts of forward-shift. Additional functional forms are applied to datasets. Independent variables that are not already in the form of returns are converted to returns. Independent variables that need to be converted to real values from nominal values are discounted by an inflation index (such as the consumer price index). Independent variables that need to be converted into a return form through a special function (such as temperature) are filtered through the appropriate function.

Next at step 308, common data frequency is formed. One possibility is to choose the highest possible common frequency. In this case, the highest common frequency among the datasets is determined and every other independent variable with higher frequency than the common frequency is reduced to the common frequency and also to the largest common time interval. This reduction can be done in many different ways. Single data points that correspond to lower frequency timestamp can be used. An example of this is taking the value at the beginning of each month of a daily time series to reduce it to a monthly data series. In another embodiment, the result of a function of the interval between the two lower frequency timestamps is used. An example of this is taking the average of all days in a month in a daily time series to reduce it to a monthly data series.

Then, at step 310, when all processing is complete and there is a data matrix with common length and frequency, the batch regression process tests models with every possible risk driver combination in the factor pool, using an arbitrary regression or time series estimation method—such as ordinary least squares (OLS), generalized least squares (GLS), maximum likelihood estimation (MLE), or generalized method of moments (GMM). An alternative method within the process determines the possible variable combinations before processing the data to form the final data matrix, therefore making maximum use of available data for each separate regression. The results for all regressions are sorted first by a metric to determine the goodness of fit. R-squared value, which is the standard OLS measure of how closely the model fits the provided data, is the corresponding metric for the OLS example.

At step 312, the results are further sorted by the significance of factor coefficients. For OLS, this is determined by a t-statistic for a particular coefficient distribution. Each coefficient is a distribution with the number of observations equaling the number of data points in our dataset for the regression. A coefficient is significant if within this distribution it is significantly different than zero in a given confidence interval. This is reflected by the t-statistic of the particular coefficient. The absolute value of the coefficient's t-statistic is greater than the critical t-value for the chosen confidence interval (example: 95% confidence interval critical t-value for 100 degrees of freedom is 1.6602) if the coefficient is significant.

In the present methods and systems, the best model is assumed to be the regression with the best fit which also has all of the coefficients significant. Factor coefficients in the model should also be sensible from an economic perspective. So the coefficients are reviewed to see if the direction (negative or positive) and the magnitude of the effect of the underlying factor seem plausible. This process is repeated with different factor pools for both the company price-proxy and market indices as the dependent variable to eventually decide upon one good linear factor model for each of these.

Although ideally every combination of factors in the comprehensive factor pool should be tested in a regression, computational resources and time often does not make this task efficient. The methodology, therefore, incorporates a recursive factor selection method to limit the maximum number of factors at any given time in the batch regression process.

FIG. 3 illustrates the recursive batch regression process that incorporates this selection method to maintain a certain maximum number of factors (or independent variables) at any single loop. The number depends on the computing resources and the efficiencies of the hardware/software system used to implement this process.

The decisions at key points in FIG. 3 constitute the factor selection method. For each key point there are several possible decisions, therefore combinations of these decisions add up to different customized selection methods. The following are some examples of these possible decisions (with the number indicating the key and the letter indicating each different method):

1.a Decide variables to start with

The process starts with the factors that are significant in literature or in previous regressions.

1.b Decide variables to start with

The correlation matrix of the universe of variables is investigated and all variables with correlations greater than or equal to a chosen threshold (e.g. 0.20) with the dependent variable (returns) are included in the initial pool.

If among any of these variables, the correlation of two variables to each other is greater than another chosen threshold (e.g. 0.50) the one with the highest correlation is picked and the other one is put into the In Bucket. See step 3 for rules regarding these family variables.

1.c Decide variables to start with

Stepwise regression, a process where variables are added and removed from the model to observe changes in statistical properties, is utilized. The process is repeated twice: Once with no factors and adding factors in (forward) and the second time with a full set of variables and taking variables out (backward) to get all variable coefficients to be significantly different than zero at an arbitrary confidence interval (e.g. 95%). If, for instance, the result is less than 4 variables at the end, then decrease the confidence level by a small amount (e.g. 5%) and keep decreasing in steps until an arbitrary level (e.g. 50%) is reached or if there are more than 4 significant variables in the resulting regression.

2. Choose variables to take out

All variables that do not show up in a regression with all significant factors (except the constant term) are taken out. A significant factor has a coefficient that is sufficiently different than zero at a specified confidence interval. This is tested with several different confidence intervals.

3. Choose variables to put in

Four variable buckets are defined as span bucket, in bucket, out bucket, and run bucket. In and out buckets start out empty. Span bucket starts with all variables in the comprehensive factor pool minus those that we are starting our regression with. Those initial active variables start out in the Run Bucket.

A variable family is a group of variables who have correlations higher than 0.5 with each other. They are a family because when included together in a regression they can cause multicolinearity, a condition in which several variables that are linearly related to one another explain the same effect in the dependent variable.

The buckets then follow these rules:

At a given time only one variable from a family can be in the Run Bucket.

When all members of a family is in the Out Bucket, the family goes back into the Span Bucket

When a member of a family goes into the Run Bucket, all others of the same family that are in Span Bucket go into the In Bucket.

When a member of a family goes into the Out Bucket (from the Run Bucket as a result of variable removal) the highest ranking (one with highest correlation to the dependent variable) family member from the In Bucket jumps into the Run Bucket.

The rest of the Run Bucket after variable removal is filled with highest ranking variables from the Span Bucket.

When a variable is put into the Out Bucket:

If the variable has a family, it stays in the out bucket until all of its family is in the Out Bucket, at which point they all get transferred into the Span Bucket after a random interval.

If the variable does not have a family, then it stays in the out bucket for a random number of runs (in a specified range) and then gets sent back into the Span Bucket.

4.a Choose significant variables to fix

If a factor is in all regressions with all significant factors, that factor is fixed in all upcoming regressions. If the next run has no success, “unfix” the factor. Fixing the factor, in this context, means the factor will be included in all factor combinations in the next run, effectively making room for one more variable to be put into the Run Bucket.

4.b Choose significant variables to fix

Top N factors, ranked according to their t-statistics, are fixed to make room for other variables. N is an arbitrary number less than the maximum number of variables we consider at one time.

5 Decide if the results are satisfactory

The results are satisfactory if R-squared is greater than a specified threshold (e.g. 40%) and all coefficients are significantly different from zero at a specified confidence level (e.g. 95%).

The present methodology incorporates different risk measures to quantify the risk in a company's business. In the discussion below and associated figures, the focus is on the non-diversifiable portion of the risk exposure. The methodology can also analyze the overall risk exposure by taking into account the component due to the diversifiable part. Each of the following risk measures have two forms: one directly applied to price-proxy and stock market returns (304), and one applied to factor decompositions of the price-proxy and stock market returns (314).

Beta is a traditional risk measure within the Capital Asset Pricing Model (CAPM) framework. It assumes that all risk is captured in the volatility of the price-proxy returns in comparison to the volatility of the market. Beta (β), along with the risk-free return (r_{∫}) in the market, defines the relationship between company's stock price (or price-proxy, r_{C}) returns and the stock market returns (r_{M}).

r_{C}=β(r_{M}−r_{∫})+r_{∫}

Beta is defined in terms of covariance and variance of r_{C} and r_{M}:

β=^{cov(r}^{_{C}}^{,r}^{_{M}}⁾/ᵥₐᵣ₍ᵣ_{_{M}}₎

Although these formulas bear a formal resemblance with CAPM, they lead to different results in general since, in accordance with an embodiment of the present invention, the individual terms are based upon price proxies and scenarios instead of stock prices and historical data. The methodology applies this risk measure directly to the dependent variables by substituting r_{M} with the returns of the chosen stock market index, and substituting r_{C} with the returns of the price-proxy for the company under different scenarios. This way the methodology produces one dependent variable Beta for each scenario from the previous steps.

When separated into risk factors (Fᵢ, Gᵢ) and sensitivities (cᵢ,αᵢ), however, the returns are redefined (also with error terms ε,δ) as follows:

$${r}_{C} = {c}_{0} + {\sum }_{F} {c}_{i} {F}_{i} + ɛ$$

$${r}_{M} = {a}_{0} + {\sum }_{G} {a}_{i} {G}_{i} + δ$$

This leads to the extended Beta definition for risk factors (independent variable Beta):

$$β = \frac{\begin{matrix}{\sum }_{F} {\sum }_{G} {c}_{i} {c}_{j} cov ( {F}_{i} {G}_{j} ) + \\ {\sum }_{F} {c}_{i} cov ( δ , {F}_{i} ) + \\ {\sum }_{G} {a}_{i} cov ( ɛ , {G}_{i} ) + cov ( δ , ɛ )\end{matrix}}{\begin{matrix}{\sum }_{G} {\sum }_{G} {a}_{i} {a}_{j} cov ( {G}_{i} {G}_{j} ) + \\ 2 {\sum }_{G} {a}_{i} cov ( δ , {G}_{i} ) + var ( δ )\end{matrix}}$$

This expansion of independent variable Beta also allows the inspection of covariance between individual factors and their contribution to the overall Beta.

VaR-Beta (Value-at-Risk Beta) is a risk measure that improves upon the traditional Beta. In the VaR-Beta framework, Value-at-Risk—a commonly used industry standard for measuring risk—is used to capture the risk instead of variances and covariances. VaR is defined as follows:

VaR(X)=η(F(X))−X(P)

Here X is a distribution (in this case either of company's price-proxy or of the stock market) and F(X) is the cumulative distribution function (cdf) of X and η(F(X)) is an arbitrary reference point within this function (ex. expected value of X) and X(P) is the inverse of F(X) and therefore the P-order percentile function of distribution X.

The relationship VaR-Beta (β_{VaR}) defines between the company price and the market return can be the same as the traditional Beta:

r_{C}=β_{Var}(r_{M}−r_{∫})+r_{∫}

And VaR-Beta is defined as:

$${β}_{VaR} = \frac{\frac{\partial VaR ( {r}_{M} )}{\partial {α}_{i}} - VaR ( {r}_{f} )}{VaR ( {r}_{M} ) - VaR ( {r}_{f} )}$$

Where αᵢ is the ratio of market value (total price-proxy) of the company to the total value of all assets in the market. An assumption can be made here to say αᵢ=0 if the company value is much lower than that of all assets in the market.

The market is assumed to be a collection of all assets, which also includes the company. Therefore:

r_{M}=ΣαⱼXⱼ and r_{C}=Xᵢ with αᵢ a, as the coefficient in the sum that makes up r_{M}.

If the reference point in VaR definition: η(F(X)) is defined to be the expected value of the distribution, than VaR(r₁₇)=0. This reduces VaR-Beta definition to:

$${β}_{VaR} = \frac{\partial VaR ( {r}_{M} ) / \partial {α}_{i}}{VaR ( {r}_{M} )}$$

This is an embodiment of a VaR-based Beta. Alternative VaR-Beta definitions exist with different assumptions. The methodology utilizes all Beta definitions incorporating Value-at-Risk as a risk metric.

The above example can be used directly on the dependent variables (company and market returns) to determine the dependent variable VaR-Beta.

VaR-Beta definitions must be extended to include independent risk factors individually, if the dependent variables are instead defined as a linear combination of independent variables (factors) as before:

$${r}_{C} = {c}_{0} + {\sum }_{F} {c}_{i} {F}_{i} + ɛ$$

$${r}_{M} = {a}_{0} + {\sum }_{G} {a}_{i} {G}_{i} + δ$$

Then the illustrative VaR example can be extended into an illustrative factor-based VaR-Beta definition:

$${β}_{VaR} = \frac{{\sum }_{F} {c}_{i} E ( {F}_{i} ) - {\sum }_{F} {c}_{i} {\tilde{F}}_{i}}{VaR ( {r}_{M} )}$$

Where \tilde{F}ᵢ is the P-order percentile value for the distribution of factor Fᵢ.

VaR of the market return can be expanded in a similar way with certain assumptions. The result is a Beta value based on the distributions of each individual risk factor driving the company and market returns.

Other alternative risk measures, besides Beta and VaR-Beta, can be used as a substitute in this step of the methodology. In particular, Expected Tail Loss (ETL) Beta can be readily implemented. ETL gives the expected loss conditional on the fact that the VaR has been breached. In other words, ETL is the mean of the distribution for values that exceed the specified VaR. In general, the use of any existing or subsequently developed risk metric and associated risk measure in conjunction with the other steps of the approach of the present methods and systems are considered to be a viable embodiment and subject to the restrictions of this patent application.

Regardless of the risk measure used, the end result of this step is an independent variable risk measure and individual independent variable (factor-based) terms building that sum to the total risk measure. Each of these terms relate to a pair of factors, one on the company-side and one on the market-side.

The covariances or higher order moment generalizations between individual factors can be generally called risk mixing terms, as they explain the contributions of individual risk factors into an overall risk measure relating the returns on a company stock price or price-proxy to the returns of the market portfolio under different scenarios.

In FIG. 3, at this step 316, the individual risk factors are analyzed to gain intuition into how well the factors explain the overall risk and to see if the models assumed for the price-proxy and the market were reasonable.

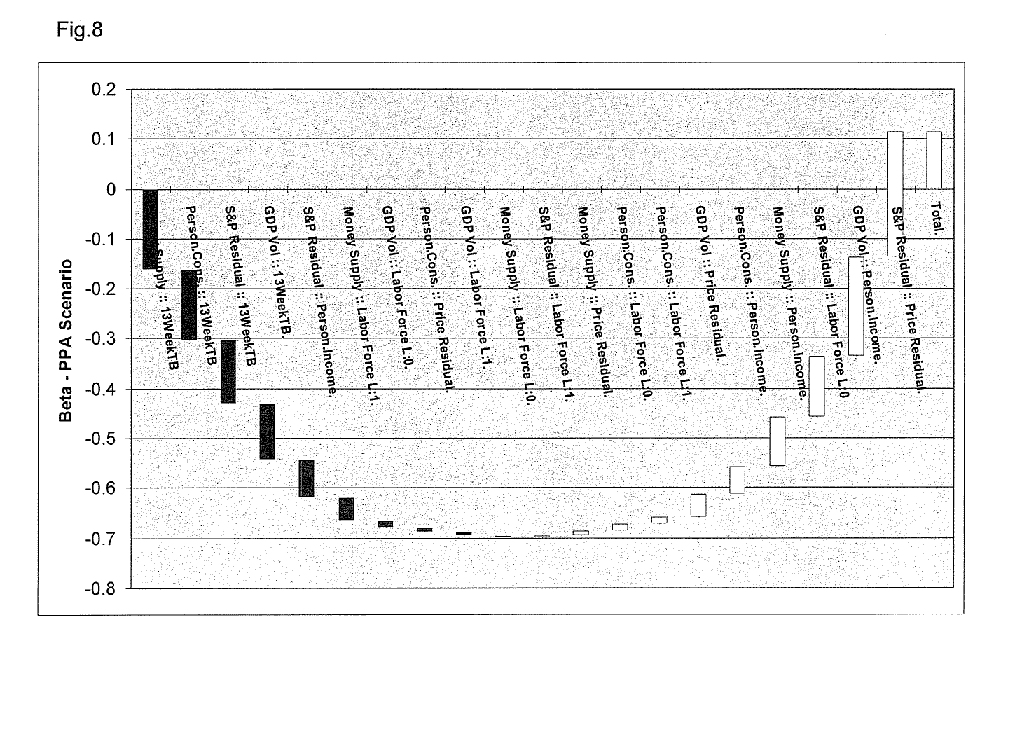

One tool used in this step is a waterfall plot, as illustrated in FIG. 8. The waterfall plot shows the contribution of each of these risk mixing terms as part of the overall risk. The significance of each pair of factors in the overall risk is observed in the waterfall plot.

In FIG. 3, at step 318, if risk mixing terms involving error terms of regressions are considerably large then intuitively it makes sense to go back to the initial steps of the process to reconsider our factor pools and our factor decomposition process. The steps including and following factor decomposition are repeated a number of times to minimize the impact of error terms in this final analysis. The error residuals from these regressions may also be used as factors in new regressions in the factor decomposition stage to see if better models can be defined with this new information.

If the error terms are persistent, then the process may be started from even an earlier stage with newer scenario definitions. Intuitive feedback received at this analysis stage may suggest other changes in the process or may take the process back to different stages within the methodology. The process finalizes and moves into the Cost of Capital Determination and analysis stage when the models and the individual risk mixing terms and results make intuitive and numerical sense, and contributions of error-based terms are minimized.

### Cost of Capital Determination

The present methods and systems provide significant flexibility in relating the entity risk measure to cost-of-capital. The functional expansion of excess returns specified in the previous step is analogous to the formulas of the capital asset pricing model (CAPM) in its simplest, single-variable, linear form. However, the meaning of the terms in the functional expansion, as well as the manner in which they are calculated, may be significantly different since they can be based upon a more general and robust risk measure and can utilize scenarios. In addition, this canonical form is not a requirement of any embodiment. The present methods and systems cover situations that include multiple explanatory variables that are placed on equal footing with the market returns. In this case, several risk proportional factors would in general be present. Furthermore, the relationship between company excess returns and the explanatory variables can be non-linear.

In the present methods and systems, adding the company excess mean return to the risk-free rate of return gives the cost of equity capital. Further, the cost of debt is determined from a company's current borrowing liability structure. Forming the notionally weighted sum of cost of debt and equity gives the Weighted Average Cost of Capital (WACC) or total company cost-of-capital. Since the WACC is formed from cost-of-equity and cost-of-equity can be written as a factor decomposition, the WACC can also be decomposed into fundamental factors. This provides a convenient visual representation of the relative contribution of the various factors and how they couple together. In the present methods and systems, the cost of equity can also be written in terms of contributions from cash flow components, enabling the WACC to be written as a sum of contributions due to individual free cash flow or earnings items. These factor/cash flow decompositions provide significant intuition and are not available when using existing methodologies.

In the present methods and systems, once the risk measure is determined, cost-of-capital can be estimated. In general, cost of equity can be related to the risk measure in a variety of ways under the present invention. For instance, it can depend on a single risk measure in a linear fashion as given by:

r_{C}=β(r_{M}−r_{∫})+r_{∫}

Alternatively, it can depend on several risk measures in a multi-linear fashion. Likewise, it could depend on the risk measure(s) non-linearly. In addition, it could split the risk measures into those due to diversifiable and non-diversifiable risk. It is to be understood that each of these alternatives is considered an embodiment of the present invention. To simplify the exposition, it will be assumed (unless otherwise specified) that a single variable, linear relationship applies. Similar considerations, apply to non-linear and/or multi-measure cases.

In the present methods and systems, the total cost-of-capital is given by weighting the cost of equity and cost of debt by the capital structure ratios to give the weighted average cost of capital (WACC). The WACC depends on cash flow components implicitly through the price proxy models. Cash flow components here, as usual, can refer to either earnings or free cash flow (FCF) components. It is therefore possible to decompose cost-of-capital into relative contributions from each cash flow component. Since most of this decomposition takes place when analyzing the risk measure(s) associated with cost of equity, it is easier to focus on the decomposition of these risk measures directly. Since we have a functional relationship between the risk measure and cost-of-capital (and vice versa) this translation can always be performed.

If a single variable, linear model is assumed, the individual returns of cash flow components can be written as:

$${r}_{i , j} = ( \frac{{c}_{i + 1 , j}}{{c}_{i , j}} - 1 ) \frac{( \frac{{\sum }_{j} {c}_{i + 1 , j}}{{\sum }_{j} {c}_{i , j}} - 1 )}{( {\sum }_{j} ( \frac{{c}_{i + 1 , j}}{{c}_{i , j}} - 1 ) )}$$

where C_{i,j} is the i-th data point (after tax) of the j-th component of the cash flow set. If we define total earnings (TE) to be:

$$TE = \frac{{\sum }_{j} {c}_{i + 1 , j}}{{\sum }_{j} {c}_{i , j}} - 1$$

$$then$$

$${r}_{i , j} = \frac{( \frac{{c}_{i + 1 , j}}{{c}_{i , j}} - 1 )}{{\sum }_{j} ( \frac{{c}_{i + 1 , j}}{{c}_{i , j}} - 1 )} TE$$

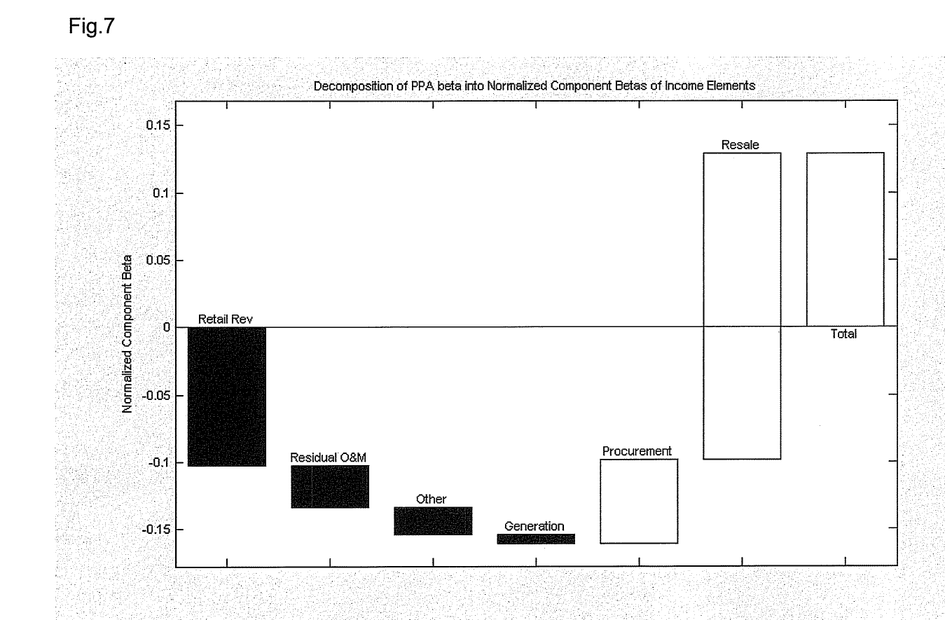

In this form the returns on individual cash flow components have been renormalized (i.e. divided by a common quantity) so that the terms generated by forming component Betas or VaR Betas sum to the total value of the risk measure. Component Betas or VaR Betas are given by the same formulas as before with total returns replaced by component returns. This decomposition is illustrated in FIG. 7. This gives great insight since it provides a manner for assessing the importance of individual cash flow components for a particular scenario. This decomposition can also be used to analyze how the relationship among these components changes across scenarios.

The present disclosure provides novel substeps or modules (such as for Scenario Specification (including Risk Factor Determination), Price-Proxy Determination, Risk Measure Determination, and Cost-of-Capital Determination), and those substeps and modules can be decoupled and usefully employed as individual substeps or modules. Therefore, the use of selected substeps or modules without applying all steps in the process is also considered to be within the scope of the present invention. In such embodiments, replaced steps can be viewed as default substitutes. For example, scenario specification and price-proxy determination could be replaced by the use of historical stock price data. This could also be interpreted as defining a default scenario based upon past price realizations. Another example would be carrying out the scenario specification and price-proxy determination steps and then utilizing existing risk measures for cost-of-capital determination.

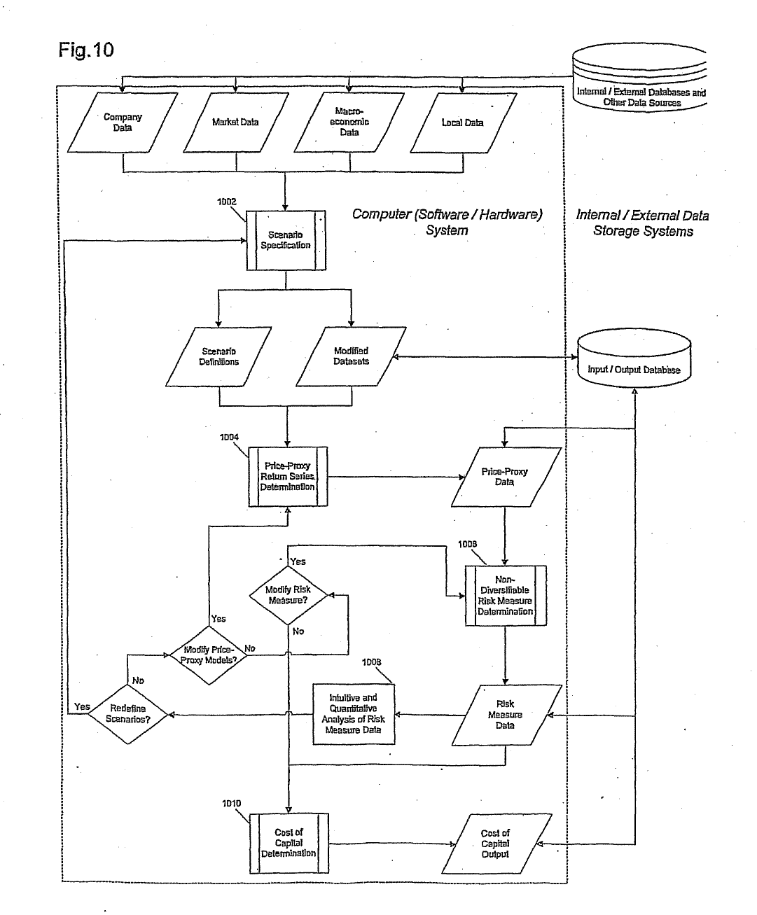

FIG. 10 illustrates a computer system implementation of an embodiment in accordance with the present invention. Modules 1002, 1004, 1006 and 1010 correspond to software/hardware implementations of an embodiment using the four steps for the case of a non-diversifiable risk measure. Module 1008 is a step of analysis. As seen in FIG. 10, Risk Measure results from module 1006 are analyzed in module 1008 to see if any previous module should be revisited with a different configuration or a different set of inputs. This step involves the software system outputting results for intuitive inspection as well as performing quantitative tests on results.

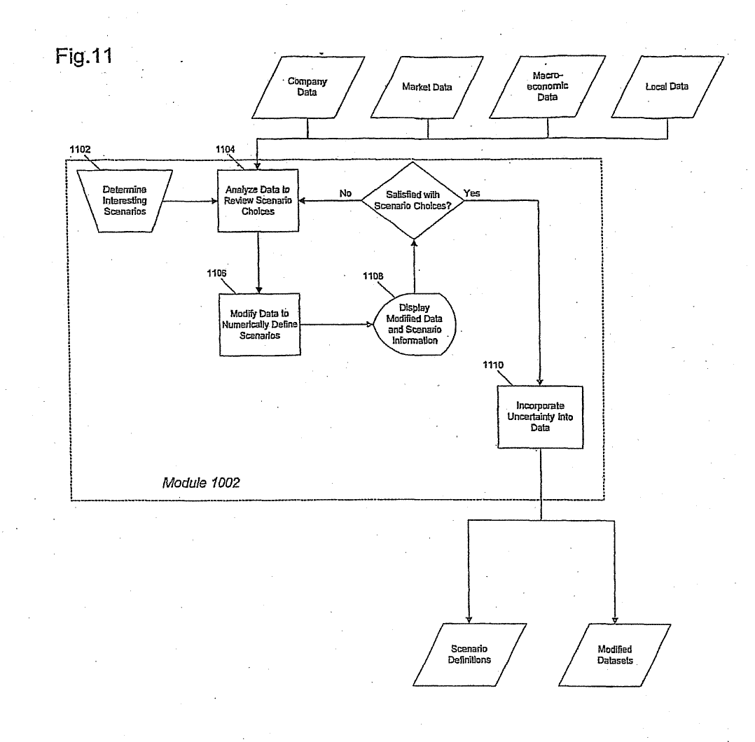

FIG. 11 is a flowchart illustrating a software/hardware implementation of Module 1002, which determines the scenarios that impact the company's cost-of-capital and to link them to the risk drivers that are used to model uncertainty. The computer system module allows the user to determine a set of scenarios that impact the company's cost-of-capital and to numerically define these scenarios within the data passed to the other core modules.

At step 1102, the user manually, with optional computer system assistance in viewing and analyzing existing data, determines which scenarios are interesting and should be further analyzed. From a variety of scenario types or classes, a set of interesting scenarios are selected. The computer system is then used to view and analyze the existing data after applying scenario constraints to review scenario choices.

Next at step 1104, the user reselects scenarios as necessary after this review. The system then translates user-defined scenario constraints into numerical data by modifying the datasets accordingly.

At step 1106, for each scenario, the system forms new datasets of company earnings components and risk factors that agree with scenario definitions and reflect the changes in the operating environment that the scenario simulates. For example, to create a volatile power market scenario, the computer system can be used to view and modify the appropriate datasets for power prices to reflect a significant increase in volatility.

Then at step 1108, these modified datasets are displayed for the user to review. If the user is not satisfied with the results, the system provides the option to revisit and alter scenario choices. The user can choose from several methods to incorporate uncertainty into the data. In the present methods and systems, historical simulation, which uses actual historical time series for data, is used to incorporate uncertainty into the data. For historical simulation, uncertainty is incorporated by choosing actual historical datasets.

In addition, specific cash flow components can be modified under various scenarios. Intuitive specification and analytic correlation are similarly methods that directly determine the datasets used and therefore are incorporated as part of the scenario definition phase. After the modified datasets are formed, the user is presented with the option to incorporate a Monte-Carlo simulation. In that case, the computer system analyzes the specified datasets for statistical properties of distributions and then uses these statistical properties to run Monte-Carlo simulations.

At step 1110, these simulations can be run on both earnings components and risk factors to get distributions for both types of datasets. All modified datasets are outputted as well as the scenario definitions.

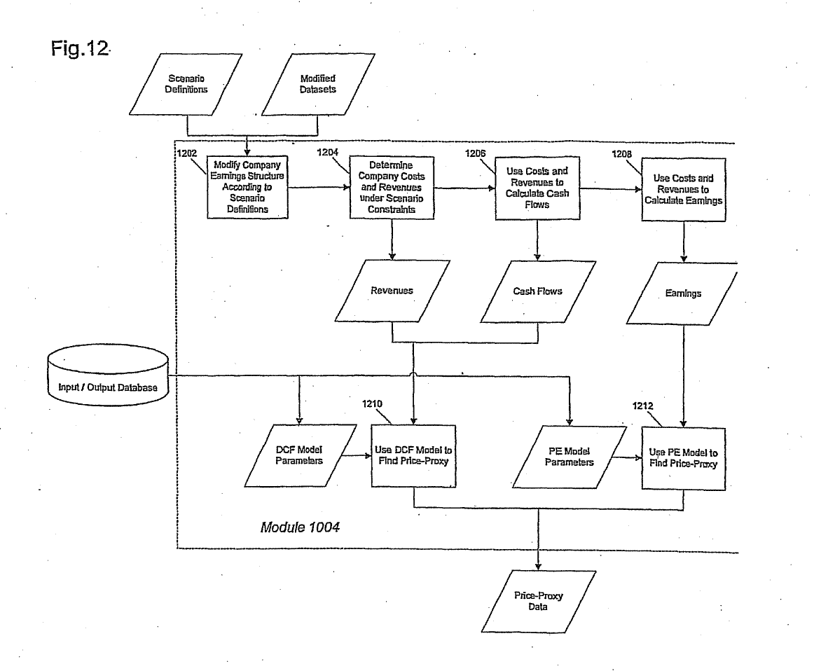

FIG. 12 is a flowchart illustrating a software/hardware implementation of Module 1004, which determines a price-proxy return series. The inputs to Module 1004 have already been modified according to scenario definitions, but some scenario definitions (such as regulatory scenarios concerning taxes) dictate modifications in the earnings structure and free cash flows of the company and therefore are incorporated at this stage.

At step 1202, the system offers analytical tools for the user to define and execute these modifications. Modified earnings components are then put back together into individual and total cost and revenue items for each scenario.

Next, at step 1204, total revenues for each scenario are outputted at this stage and can be used later in the DCF Price Model. The computer system then compares costs and revenue items to a user-defined list of cash-flow components to form cash-flow series.

Then, at step 1206, cash flows for each scenario are outputted at this stage to be used later in the DCF Price Model. Finally costs and revenues are used to calculate total company earnings under each different scenario.

At step 1208, earnings for each scenario are outputted at this stage to be used later in the PE Price Model. The computer system then uses the DCF Price Model and takes in user-defined model parameters, revenues and cash flows as input to compute a price-proxy for the company under different scenarios.

Then at step 1210, price-proxy series for different DCF Price Model configurations and for each different scenario are outputted at this stage. The system uses the PE Price Model and takes in user-defined model parameters and company earnings to compute a price-proxy for the company under different scenarios.

At step 1212, price-proxy series for different PE Price Model configurations and for each different scenario are outputted at this stage.

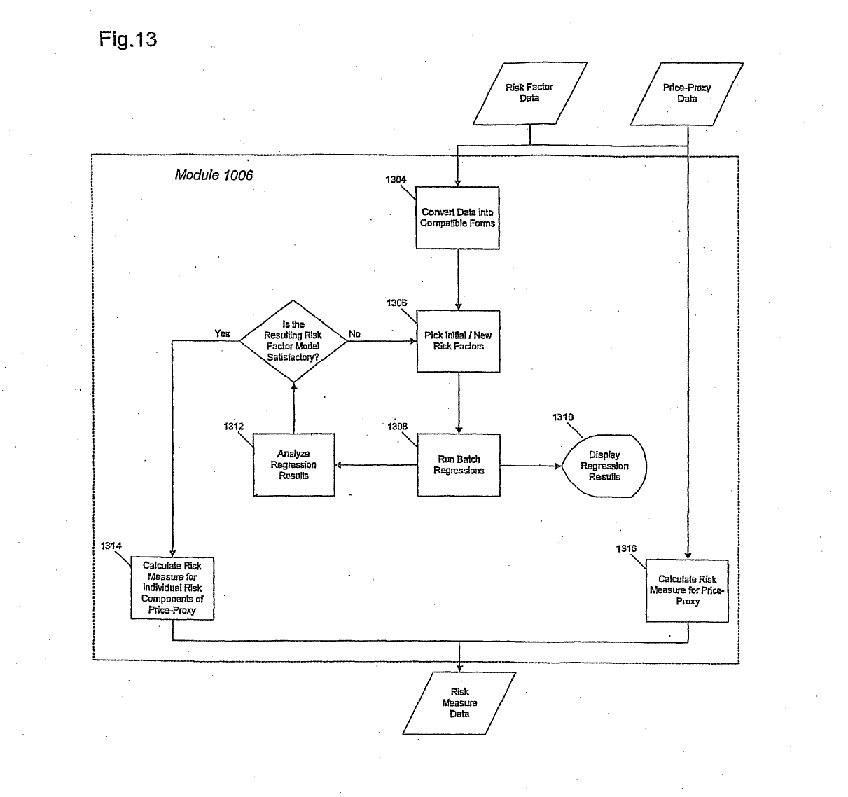

FIG. 13 is a flowchart illustrating a software/hardware implementation of Module 1006, which determines a non-diversifiable risk measure.

At steps 1314 and 1316, Module 1006 either decomposes the price-proxy series into several risk factors and then performs a risk measure calculation (1314), or it takes the price-proxy series passed from the previous core module and calculates the risk measure directly on the price-proxy series (1316).

In order to proceed with factor decomposition (1314), all risk factor datasets are converted into compatible forms by the computer system at step 1304. Data that is in price form is converted into returns. Temperature functions are used to find proxies for “temperature returns”. Other transformations on data such as lags and polynomials are also performed at this stage.

At step 1306, the system of user-defined criteria is used by the system to pick a set of initial risk factors from the global set of factors to form a factor pool. This factor pool is of limited size due to computational resource limitations again manually defined by the user or determined by the software/hardware system. If this step is being revisited, then factors that did not meet user-defined criteria in the past batch regression processes are thrown out and replaced by new factors from the global factor pool. One such set of criteria can be the illustrative bucket system explained before. In this system, the run bucket is equivalent to the factor pool and the global pool represents all factors in any bucket.

Next, at steps 1308, 1310, and 1312, the computer system implements the Batch Regression system complete with the buckets for variables/risk factors as previously described and illustrated in FIG. 3.

At step 1308, the system runs OLS regressions with every single combination of the factor pool to find the best factor model to explain price-proxy returns with individual risk components.

Then, at step 1310, regression results are displayed to the user along with statistical properties of each model suggested by each OLS regression, sorted by user-defined criteria, such as the R-squared value and/or the significance of risk factor coefficients.

Next, at step 1312, the system then analyzes regression results to see if the regressions with the highest explanatory value also have highly significant coefficients. In general regression statistics are tested against user-defined criteria to determine whether suggested models are satisfactory. If a satisfactory model is not found within the returned results, new factors are picked.

At step 1314, the computer system uses a selected risk-measure (such as Beta or VaR-Beta) to determine contributions of each risk factor into the overall risk measure.

Then, at step 1316, if price-proxy returns are used directly to compute the total risk measure, then the risk-measure is applied only to these returns without the factor decomposition.

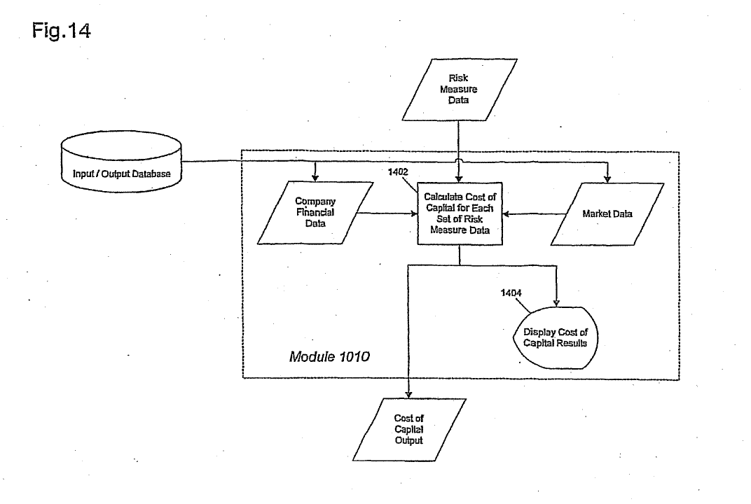

FIG. 14 is a flowchart illustrating a software/hardware implementation of Module 1010, which determines the cost-of-capital. Module 1010 uses the company finances, market data, risk measure data and measurements to determine the company cost-of-capital.

At step 1402, the cost-of-capital, either as a single value or in distribution form, is calculated for each individual scenario.

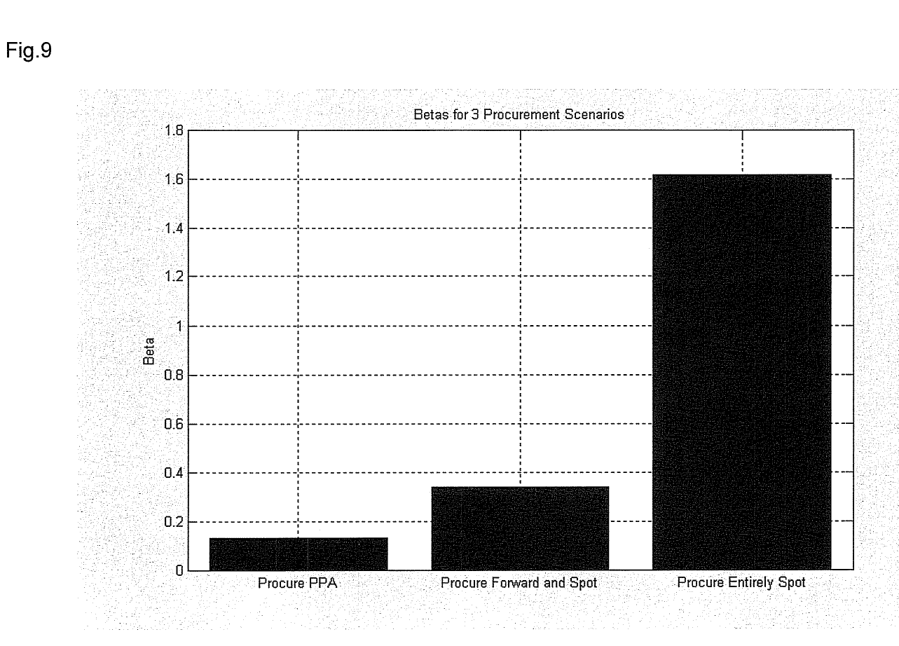

Then, at step 1404, the system displays the calculated cost-of-capital information, such as a decomposition of the overall risk measure into cash flow components (See FIG. 7), the waterfall plots (See FIG. 8) that show the break-down of the overall risk measure into individual risk components from fundamental factors, or charts where cost-of-capital estimates for each scenario can be viewed together and compared (See FIG. 9).

The present methods and systems can be applied in a multitude of applications within the electric utility industry, as well in many other business sectors. Some of these applications include, but are not limited to direct regulatory application, indirect regulatory application, asset valuation, M&A support, tax liability assessment, divisional cost-of-capital estimation, transfer pricing and internal capital charges, and implicit use of allowed cost-of-capital for internal planning purposes, and valuation and pricing within a network system.

For direct regulatory application, the present methods and systems can be are used to support direct testimony in utility cost-of-capital rate cases. The present methods and systems can be are used to replace or supplement existing methodologies in this respect. For example, in situations where an embodiment is used to supplement existing methodologies, it could be used to argue for a cost-of-capital estimate that is at the high end of the range given by existing methodologies. The present methods and systems can significantly extend the ability to interface the technical estimation argument with the policy discussion, since the methodology would provide greater intuition about risk drivers compared with existing methodologies. The tangible result is a regulated electricity rate.

For indirect regulatory application, the present methods and systems can be used to support regulatory proceedings in which cost-of-capital estimation is not the key focus. Examples of this include, but are not limited to, regulatory approval of integrated resource plans (IRP's), procurement filings, and submission of arguments for regulatory mechanism modifications. For example, the present methods and systems can be used in procurement filings to demonstrate how different choices of procurement methods lead to different internal cost-of-capital estimates. This would enable the methodology to be cited formally in the regulatory community prior to determination of cost-of-capital in a rate case. In addition, the methodology is used to educate the regulatory community prior to full rate cases via discussions, presentations, and documents provided for inspection to commissioners or staff. The tangible provided is a regulated electricity rate.

For asset valuation, the present methods and systems can be used for the purposes of valuation of existing or potential company assets, using asset specific cost-of-capital estimates for risk adjusted discounting purposes. These assets may include, but are not limited to, generation, transmission, distribution, fuel storage facility, fuel supply, contractual, and financial portfolio assets. Although existing methodologies may provide a means for determining discount rates, they fail to take into account the full set of risks that materially affect the operating cash flows associated with the asset in question. The present methods and systems, on the other hand, model these risks directly and incorporate them naturally into the valuation analysis. The present methods and systems can be used for both relative and absolute valuation purposes. Relative valuation is accomplished by scaling or interpolating the cost-of-capital of an asset relative to the externally specified cost-of-capital of other assets. This is achieved by analyzing the ratio of the risk measures of the assets. The externally specified cost-of-capital values, which are inputs, serve as benchmarks and the cost-of-capital estimates calculated from the present methods provide a basis for determining the relative risk exposure and market value of a wide variety of assets. Absolute valuation is accomplished by estimating an asset's cost of capital without the use of externally specified cost-of-capital values for other assets. The tangible result is a valuation along with the purchase or sale of an asset.

For M&A support, the present methods and systems are used to value individual companies, divisions, or assets by determining the appropriate discount rate of projected cash flows over some time horizon. This enables the present methods and systems to be used as a tool to determine the relative attractiveness of buying or selling a company or group of companies. Since the present methods and systems are scenario based, this provides significant leverage in developing a negotiation strategy. In particular, worst case scenarios can be used to bolster the argument for a higher or lower price, as well as provide a band of “acceptable” purchase/sale prices. The tangible result is a valuation of the subsidiary or division along with purchase or sale of the subsidiary or division.

For tax liability assessment, the present methods and systems are used to assist utilities in making an argument for lower property tax liabilities in the presence of assets with significant risk. The present methods and systems would enable the inclusion of many types of risks that are not captured by existing approaches such as environmental risk, outage risk, and asset-mix (diversity) risk. A higher risk would lead to a higher discount rate, and thus a lower present value and correspondingly lower tax burden. The tangible result is a tax liability for the company's assets.

For divisional cost-of-capital estimation, the present methods and systems are used to determine the cost-of-capital of each operating subsidiary or division. Furthermore, the present methods and systems are used to analyze the relationship between the sum of individual subsidiary cost-of-capital estimates and the total holding company cost-of-capital. Additionally, the present methods and systems are used to analyze the synergies among the subsidiaries or divisions, or the synergies between the subsidiaries or divisions and the holding company. Existing methodologies either assign the same (holding-company) cost-of-capital to all subsidiaries or use analysis of comparable subsidiaries at other utilities. Both of these approaches are flawed since the risks that different subsidiaries face are driven by their operating structure. The present methods and systems avoid these difficulties by modeling the risks that the subsidiary faces from the bottom-up. The tangible result is altered cash flows between a holding company and its subsidiaries or divisions.

For transfer pricing and internal capital charges, the present methods and systems are used to determine the target rate of return required by a holding company on capital allocated to internal subsidiaries. Subsidiaries with higher risk exposure will have higher cost-of-capital estimates, enabling holding companies to charge subsidiaries in line with actual risk exposure. This method has a considerable advantage over existing ad-hoc procedures that, fail to incorporate risk allocation considerations. The tangible result is altered cash flows between a holding company and its subsidiaries or divisions.

For implicit use of allowed cost-of-capital for internal planning purposes, the present methods and systems are used implicitly for internal planning and risk management activities. Whether the utility is successful in receiving the proposed cost-of-capital or not, the methodology is used to determine the nature of the internal activities consistent with the allowed cost-of-capital. Risky activities are modified or eliminated to be brought in line with this regulatory constraint. The present methods and systems enable a consistent treatment of internal risk management practices and regulatory analysis, which is unnatural or unfeasible in existing methodologies since they do not model risks in a bottom-up manner. The tangible result is altered operational structure or a change to the company's budget.

For valuation and pricing within a network system, the present methods and systems can be used to value embedded goods and services that are transferred between locations in the network system. Examples of such network systems include but are not limited to electric power transmission systems, electric power distribution systems, electric power generation systems, electric distributed generation power systems, gas pipeline systems, gas storage systems, oil pipeline systems, and telecommunication systems. Examples of services that can be priced are spot and forward energy prices of electricity, capacity charges for electricity, grid transmission charges for electricity, charges for electric ancillary services such as voltage regulation and load balancing, spot and forward energy prices for natural gas, spot and forward energy prices for oil, and capacity and usage charges of broadband consumption. Optimal pricing of such services provides proper price signals to consumers. The present method and systems provide improvements over existing pricing mechanisms by explicitly modeling the risk drivers that impact the value of such services. The present methods and systems to price network services can be used to change the manner in which the physical systems are operated. Examples of such operational changes include but are not limited to load flows on an electric transmission or distribution system, unit commitment and dispatch of electric generation facilities, delivery patterns in gas and oil systems, and consumption patterns in telecommunications systems. The tangible result is altered physical configurations and operational behavior of network systems.

All patents, test procedures, and other documents cited herein are fully incorporated by reference to the extent such disclosure is not inconsistent with this invention and for all jurisdictions in which such incorporation is permitted.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Although the dependent claims have single dependencies in accordance with U.S. patent practice, each of the features in any of the dependent claims can be combined with each of the features of other dependent claims or the main claim.

1. A method for determining a cost-of-capital for a business entity, the method comprising:
providing one or more risk drivers by identifying one or more scenarios, each scenario having a potential impact on one or more risk drivers, and quantifying said one or more risk drivers for each scenario;
determining one or more entity returns, and optionally one or more market returns, based on said one or more risk drivers;
determining one or more entity risk measures based on the entity returns and optionally the market returns;
determining a cost-of-capital for the entity based on one or more of the entity risk measures; and
determining a price or rate for goods or services based on the cost-of-capital for the entity, or determining a capital charge based on the cost-of-capital for the entity, or determining a tax liability of the entity based on the cost-of-capital for the entity, or determining a budget for the entity based on the cost-of-capital for the entity, or acquiring or selling an entity based on the cost-of-capital for the entity, or offering to acquire or sell an entity based on the cost-of-capital for the entity.

2. The method of claim 1 wherein the entity returns are determined using price-proxies determined based on the risk drivers.

3. The method of claim 1 wherein the market returns are determined using price-proxies determined based on the risk drivers.

4. The method of claim 1 wherein the entity returns are determined by mapping the risk drivers to the entity returns.

5. The method of claim 1 wherein the market returns are determined by mapping the risk drivers to the market returns.

6-11. (canceled)

12. The method of claim 1 wherein the risk drivers comprise one or more of a cash flow component and a fundamental factor.

13. The method of claim 12 wherein the cash flow components comprise one or more of an earnings component and a free cash flow.

14-20. (canceled)

21. The method of claim 1 wherein the entity risk measure is a measure of non-diversifiable risk or total risk.

22. (canceled)

23. The method of claim 1 wherein one or more of the scenarios is identified using at least one of historical simulation, Monte Carlo simulation, correlation structure analysis, and intuitive specification through sensitivity analysis.

24. The method of claim 1 wherein the price-proxies are determined using one or more of a discounted cash flow (DCF) method, a price-to-earnings (P/E) ratio method, a stochastic price model, a stock price of a comparable company, a stock price of the holding company of the entity, and a stock price of the entity.

25. The method of claim 1 wherein the entity risk measure is determined using one or more of the following methods: variances and covariances, Value-at-Risk (VaR), and Expected Tail Loss (ETL).

26. The method of claim 1 further comprising the step of decomposing at least one of the entity cost-of-capital, the entity risk measure, and the entity returns into cash flow components.

27. The method of claim 26 further comprising the steps of renormalizing the cash flow decomposition of the entity cost-of-capital so that a sum of elements of the renormalized cash flow decomposition of the entity cost-of-capital is equal to the total entity cost-of-capital.

28. The method of claim 27 further comprising the steps of displaying the said sum of the renormalized cash flow decomposition of the entity cost-of-capital.

29. The method of claim 26 further comprising the steps of renormalizing the cash flow decomposition of the entity risk measure so that a sum of elements of the renormalized cash flow decomposition of the entity risk measure is equal to the total entity risk measure.

30. The method of claim 29 further comprising the steps of displaying the said sum of the renormalized cash flow decomposition of the entity risk measure.

31. The method of claim 26 further comprising the steps of renormalizing the cash flow decomposition of the entity returns so that a sum of elements of the renormalized cash flow decomposition of the entity returns is equal to the total entity returns.

32. The method of claim 31 further comprising the steps of displaying the said sum of the renormalized cash flow decomposition of the entity returns.

33. The method of claim 1 further comprising the step of decomposing at least one of the entity cost-of-capital, the entity risk measure, and the entity returns into a plurality of fundamental factors.

34-35. (canceled)

36. The method of claim 33 further comprising the step of displaying at least one of the entity cost-of-capital, the entity risk measure, and the entity returns in a waterfall plot using a sum of sample moments of the quantified fundamental factors and sensitivities of the quantified fundamental factors.

37. The method of claim 1 wherein the risk measure is related to the cost-of-capital in at least one of linear, multi-linear, and non-linear fashion.

38-40. (canceled)

41. A system for calculating a cost-of-capital for a business entity, the system comprising:
a module for quantifying one or more risk based on one or more scenarios, each scenario having a potential impact on one or more risk drivers;
a module for determining one or more entity returns, and optionally one or more market returns, based on said one or more risk drivers;
a module for determining one or more entity risk measures based on the entity returns and optionally the market returns; and
a module for determining a cost-of-capital for the entity based on one or more of the entity risk measures.

42. The system of claim 41, further comprising one or more of a module for determining a price or rate for goods or services based on the cost-of-capital for the entity, or a module for determining a capital charge based on the cost-of-capital for the entity, or a module for determining the tax liability of the entity based on the cost-of-capital for the entity, or a module for determining a budget for the entity based on the cost-of-capital for the entity, or a module for determining whether to acquire or sell an entity based on the cost-of-capital for the entity.

43. The system of claim 41 wherein the system is implemented in a computer hardware architecture having one or more computer processors.

44-45. (canceled)

46. A computer-readable storage medium including a set of instructions for a computer, the set of instructions comprising:
a scenario specification routine for identifying one or more scenarios and providing one or more risk drivers based on at least one identified scenario;
a return series determination routine for using the one or more risk drivers to determine one or more entity returns, and optionally one or more market returns;
a risk measure determination routine for using the entity returns and optionally the market returns to determine one or more entity risk measures;
a cost-of-capital determination routine for using the one or more entity risk measures to determine a cost-of-capital for the entity.

47-56. (canceled)
